(19) United States
(12) Patent Application Publication
(10) Pub. No.: US 2025/0190780 A1
(43) Pub. Date: Jun. 12, 2025

(54) SKETCH-BASED TABULAR REPRESENTATION LEARNING FOR DATASET DISCOVERY

(71) Applicant: INTERNATIONAL BUSINESS MACHINES CORPORATION, ARMONK, NY (US)

(72) Inventors: Kavitha Srinivas, Port Chester, NY (US); Horst Cornelius Samulowitz, Armonk, NY (US); Udayan Khurana, White Plains, NY (US); Julian Timothy Dolby, Bronx, NY (US); IBRAHIM ABDELAZIZ, TARRYTOWN, NY (US); SUBHAJIT CHAUDHURY, White Plains, NY (US)

(21) Appl. No.: 18/533,286

(22) Filed: Dec. 8, 2023

(51) Int. Cl. G06N 3/08; G06N 3/0455

(52) U.S. Cl. CPC G06N 3/08; G06N 3/0455

(57) ABSTRACT

A method, computer system, and a computer program product are provided. Training data in tabular form having at least some columns is received. One or more sketches for contents of the respective columns are created. The sketches are combined with metadata embeddings of the training data to form respective combined input vectors. A transformer architecture machine learning model is trained by computing loss based on an objective function, by inputting the combined input vectors into the transformer architecture machine learning model, and, in response, the transformer architecture machine learning model producing an output.

### BACKGROUND

The present invention relates generally to the fields of machine learning, machine learning training, machine learning analysis of tabular data, and navigating data lakes.

### SUMMARY

According to one exemplary embodiment, a computer-implemented method is provided. Training data in tabular form having at least some columns is received. One or more sketches for contents of the respective columns are created. The sketches are combined with metadata embeddings of the training data to form respective combined input vectors. A transformer architecture machine learning model is trained by computing loss based on an objective function, by inputting the combined input vectors into the transformer architecture machine learning model and, in response, the transformer architecture machine learning model producing an output. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a sketch-based tabular learning representation pipeline according to at least one embodiment;

FIG. 2 illustrates column and table description masking steps that occur for training the sketch-based tabular learning foundational model according to at least one embodiment;

FIG. 3 illustrates a table curation process for generating a unionability or joining finetuning training dataset according to at least one embodiment;

FIG. 4 illustrates various tables illustrating aspects of unionability tasks according to at least one embodiment;

FIG. 5 illustrates various tables illustrating aspects of unionability and joinability tasks according to at least one embodiment;

FIG. 6 illustrates various tables illustrating aspects of joinability tasks according to at least one embodiment;

FIG. 7 illustrates tables illustrating aspects of subset identification tasks according to at least one embodiment;

FIG. 8 illustrates various tables illustrating other aspects of subset identification tasks according to at least one embodiment; and

FIG. 9 illustrates a networked computer environment in which sketch-based tabular learning representation training and usage is performed according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

According to one exemplary embodiment, a computer-implemented method is provided. Training data in tabular form having at least some columns is received. One or more sketches for contents of the respective columns are created. The sketches are combined with metadata embeddings of the training data to form respective combined input vectors. A transformer architecture machine learning model is trained by computing loss based on an objective function, by inputting the combined input vectors into the transformer architecture machine learning model and, in response, the transformer architecture machine learning model producing an output.

In this manner, dataset discovery over data lakes can be improved by the generation of an enhanced machine learning model which achieves better performance in performing tabular dataset discovery tasks in response to receiving a tabular input. In this manner, enterprises receive a new technical tool to intelligently navigate data lakes to identify relevant data tables. The sketch techniques are added with the machine learning techniques to help generate more searchable representations of column data that contain huge amounts of data.

According to one enhancement of the above-described method, the objective function includes a masking function including masking portions of the combined input vectors so that the transformer architecture machine learning model learns to predict the masked portions. In this manner, textual machine learning training techniques are harnessed to help the model develop contextual understanding of the sequence of table elements.

According to one enhancement of the above-described method, the masked portion includes at least one of column names and table description portions. In this manner, easily-accessed table information is used with textual machine learning training techniques to help the model develop contextual understanding of the sequence of table elements.

According to one enhancement of one or more of the above-described methods, for the training, cross-entropy loss is computed for the predictions for the respective masked portions, the original portion is a label, and a vocabulary set for the transformer architecture machine learning model is a set of possible labels. In this manner, machine learning loss optimization techniques are implemented to help the ML model learn to recognize relevant portions of tabular data to facilitate improved automated search of a data lake.

According to one enhancement of one or more of the above-described methods, the masking includes at least one of whole column name masking and parts-of-table-description masking. In this manner, existing training data is used as labels to help a machine learning model receive supervised training to better learn training information and to eventually be able to better perform automated search of a data lake.

According to one enhancement of one or more of the above-described methods, the sketches are passed through a linear layer of the transformer architecture machine learning model to produce modified sketches that include same hidden state dimensions as layers of the transformer architecture machine learning model. The modified sketches are used for the combining with the metadata embeddings. In this manner, sketch information in numerical form is converted into a format that is receivable and useable by a bi-directional encoder text-based transformer machine learning model so that machine learning analysis is performable on the sketch information.

According to one enhancement of one or more of the above-described methods, the metadata embeddings include one or more of column name token embeddings, column name token position embeddings, column position embeddings, and column type embeddings. In this manner, specific column metadata is used to enhance the representation of sketch information that facilitates ease of search for tabular data with numerous rows and columns of data.

According to one enhancement of one or more of the above-described methods, the sketches include one or more of numerical sketches, MinHash sketches, and row-based string sketches. In this manner, specific column data is converted to succinct representations to facilitate ease of search for input samples with respect to large databases which can contain large amount of searchable data in tabular form.

According to one enhancement of one or more of the above-described methods, the sketches include numerical sketches that include one or more of number of NaNs, number of unique values, cell width in bytes, percentile sketches, mean value, standard deviation, minimum value, and maximum value. In this manner, specific column data is converted to succinct numerical representations to facilitate ease of search for input samples with respect to large databases which can contain large amount of searchable data in tabular form.

According to one enhancement of one or more of the above-described methods, the sketches include first MinHash sketches for cell values of the columns and also include second MinHash sketches using individual tokens in string columns of the columns. The first MinHash sketches and the second MinHash sketches are concatenated into a single input vector for the string columns. In this manner, specific column data such as string values are converted to multiple succinct representations to facilitate semantic meaning capture and ease of search for input samples with respect to large databases which can contain large amount of searchable data in tabular form.

According to one enhancement of one or more of the above-described methods, the metadata embeddings include column position embeddings ranging from one to a total number of the columns. In this manner, semantics related to positioning of columns within a table are better captured by the machine learning to help achieve meaningful search through a data lake.

According to one enhancement of one or more of the above-described methods, a respective type of the columns is determined. The metadata embeddings include column type embeddings based on the determining. In this manner, data type information in columns is identified in an automated manner to facilitate improved machine learning search through a data lake.

According to one enhancement of one or more of the above-described methods, for the training an attention mechanism of the transformer architecture machine learning model learns N² attention weights between all N tokens for a given table. In this manner, machine learning techniques are implemented to help the ML model recognize most important parts of an input token sequence to facilitate automated search of a data lake.

According to one enhancement of one or more of the above-described methods, the objective function includes a table identification task for tables with alternative column ordering. In this manner, an alternative loss machine learning optimization machine technique is used to train a machine learning model that can improve dataset discovery over data lakes.

According to one enhancement of one or more of the above-described methods, the trained transformer architecture machine learning model is finetuned for a data discovery task that includes one or more of joinability, unionability, and subset identification. In this manner, a machine learning model trained to be more tabular aware is updated to complete a specific desirable task to help with automated search of a data lake.

According to one enhancement of one or more of the above-described methods, a new dataset in tabular form that includes at least some columns is input into the trained transformer architecture machine learning model. In response to the inputting, an output from the trained transformed architecture machine learning model is received. In this manner, a trained machine learning model is used to help automatically navigate a data lake to find related tables to a tabular input sample.

According to one enhancement of one or more of the above-described methods, the output from the trained transformer architecture machine learning model includes a stored dataset that semantically matches the new dataset. In this manner, machine learning semantic search tools are harnessed to help automatically navigate a data lake to find related tables to a tabular input sample.

According to one enhancement of one or more of the above-described methods, the output from the trained transformer architecture machine learning model includes one or more of a stored dataset in tabular form that includes at least some columns, a topic to which the new dataset belongs, and a concept to which a particular column of the new dataset belongs. In this manner, a trained machine learning model is used to help automatically navigate a data lake to find related tables to a tabular input sample.

According to one exemplary embodiment, a computer system is provided that includes one or more processors, one or more computer-readable memories, and program instructions stored on at least one of the one or more computer-readable memories for execution by at least one of the one or more processors. This execution causes the computer system to receive training data in tabular form having at least some columns, to create one or more sketches for contents of the respective columns, to combine the sketches with metadata embeddings of the training data to form respective combined input vectors, and to train a transformer architecture machine learning model by computing loss based on an objective function, inputting the combined input vectors into the transformer architecture machine learning model, and, in response, the transformer architecture machine learning model producing an output.

In this manner, the computer system improves dataset discovery over data lakes by the generation of an enhanced machine learning model which achieves better performance in performing tabular dataset discovery tasks in response to receiving a tabular input. In this manner, enterprises receive a new technical tool to intelligently navigate data lakes to identify relevant data tables. The sketch techniques are added with the machine learning techniques to help generate more searchable representations of column data that contain huge amounts of data.

According to one enhancement of the above-described computer system, the objective function includes a masking function including masking portions of the combined input vectors so that the transformer architecture machine learning model learns to predict the masked portions. In this manner, the computer system harnesses textual machine learning training techniques to help the model develop contextual understanding of the sequence of table elements.

According to one enhancement of the above-described method, the masked portion includes at least one of column names and table description portions. In this manner, easily-accessed table information is used with textual machine learning training techniques to help the model develop contextual understanding of the sequence of table elements.

According to one enhancement of one or more of the above-described computer systems, the computer system computes for the training, cross-entropy loss for the predictions for the respective masked portions, uses the original portion as a label, and uses a vocabulary set for the transformer architecture machine learning model as a set of possible labels. In this manner, the computer system uses machine learning loss optimization techniques to help the ML model learn to recognize relevant portions of tabular data to facilitate improved automated search of a data lake.

According to one enhancement of one or more of the above-described computer systems, the computer system performs masking that includes at least one of whole column name masking and parts-of-table-description masking. In this manner, the computer system uses existing training data as labels to help a machine learning model receive supervised training to better learn training information and to eventually be able to better perform automated search of a data lake.

According to one enhancement of one or more of the above-described computer systems, the computer system passes the sketches through a linear layer of the transformer architecture machine learning model to produce modified sketches that include same hidden state dimensions as layers of the transformer architecture machine learning model. The modified sketches are used for the combining with the metadata embeddings. In this manner, the computer system converts sketch information in numerical form into a format that is receivable and useable by a bi-directional encoder text-based transformer machine learning model so that machine learning analysis is performable on the sketch information.

According to one enhancement of one or more of the above-described computer systems, the metadata embeddings include one or more of column name token embeddings, column name token position embeddings, column position embeddings, and column type embeddings. In this manner, the computer system uses specific column metadata to enhance the representation of sketch information that facilitates ease of search for tabular data with numerous rows and columns of data.

According to one enhancement of one or more of the above-described computer systems, the sketches include one or more of numerical sketches, MinHash sketches, and row-based string sketches. In this manner, the computer system converts specific column data to succinct representations to facilitate ease of search for input samples with respect to large databases which can contain large amount of searchable data in tabular form.

According to one enhancement of one or more of the above-described computer systems, the sketches include numerical sketches that include one or more of number of NaNs, number of unique values, cell width in bytes, percentile sketches, mean value, standard deviation, minimum value, and maximum value. In this manner, the computer system convert specific column data to succinct numerical representations to facilitate ease of search for input samples with respect to large databases which can contain large amount of searchable data in tabular form.

According to one enhancement of one or more of the above-described computer systems, the sketches include first MinHash sketches for cell values of the columns and also include second MinHash sketches using individual tokens in string columns of the columns. The first MinHash sketches and the second MinHash sketches are concatenated into a single input vector for the string columns. In this manner, the computer system converts specific column data such as string values to multiple succinct representations to facilitate semantic meaning capture and ease of search for input samples with respect to large databases which can contain large amount of searchable data in tabular form.

According to one enhancement of one or more of the above-described computer systems, the metadata embeddings include column position embeddings ranging from one to a total number of the columns. In this manner, the computer system uses semantics related to positioning of columns within a table to better achieve meaningful search through a data lake.

According to one enhancement of one or more of the above-described computer systems, a respective type of the columns is determined. The metadata embeddings include column type embeddings based on the determining. In this manner, the computer system identifies data type information in columns in an automated manner to facilitate improved machine learning search through a data lake.

According to one enhancement of one or more of the above-described computer systems, the computer system trains an attention mechanism of the transformer architecture machine learning model to learn N² attention weights between all N tokens for a given table. In this manner, the computer system implements machine learning techniques to help the ML model recognize most important parts of an input token sequence to facilitate automated search of a data lake.

According to one enhancement of one or more of the above-described computer systems, the objective function includes a table identification task for tables with alternative column ordering. In this manner, the computer system uses an alternative loss machine learning optimization machine technique to train a machine learning model that can improve dataset discovery over data lakes.

According to one enhancement of one or more of the above-described computer systems, the computer system performs finetuning of the trained transformer architecture machine learning model for a data discovery task that includes one or more of joinability, unionability, and subset identification. In this manner, the computer system trains a machine learning model to be more tabular aware is updated to complete a specific desirable task to help with automated search of a data lake.

According to one enhancement of one or more of the above-described computer systems, the computer system inputs a new dataset in tabular form that includes at least some columns into the trained transformer architecture machine learning model. In response to the inputting, an output from the trained transformed architecture machine learning model is received. In this manner, the computer system uses a trained machine learning model to help automatically navigate a data lake to find related tables to a tabular input sample.

According to one enhancement of one or more of the above-described computer systems, the output from the trained transformer architecture machine learning model includes one or more of a stored dataset in tabular form that includes at least some columns, a topic to which the new dataset belongs, and a concept to which a particular column of the new dataset belongs. In this manner, the computer system uses a trained machine learning model to help automatically navigate a data lake to find related tables to a tabular input sample.

According to one enhancement of one or more of the above-described computer systems, the output from the trained transformer architecture machine learning model includes a stored dataset that semantically matches the new dataset. In this manner, the computer system harnesses machine learning semantic search tools to help automatically navigate a data lake to find related tables to a tabular input sample.

According to one exemplary embodiment, a computer program product is provided that includes a computer-readable storage medium having program instructions embodied therewith. The program instructions are executable by a computer to cause the computer to receive training data in tabular form having at least some columns, to create one or more sketches for contents of the respective columns, to combine the sketches with metadata embeddings of the training data to form respective combined input vectors, and to train a transformer architecture machine learning model by computing loss based on an objective function, inputting the combined input vectors into the transformer architecture machine learning model, and, in response, the transformer architecture machine learning model producing an output.

In this manner, the computer program product improves dataset discovery over data lakes by the generation of an enhanced machine learning model which achieves better performance in performing tabular dataset discovery tasks in response to receiving a tabular input. In this manner, enterprises receive a new technical tool to intelligently navigate data lakes to identify relevant data tables. The sketch techniques are added with the machine learning techniques to help generate more searchable representations of column data that contain huge amounts of data.

According to one enhancement of the above-described computer system, the objective function includes a masking function including masking portions of the combined input vectors so that the transformer architecture machine learning model learns to predict the masked portions. In this manner, the computer system harnesses textual machine learning training techniques to help the model develop contextual understanding of the sequence of table elements.

According to one enhancement of the above-described method, the masked portion includes at least one of column names and table description portions. In this manner, easily-accessed table information is used with textual machine learning training techniques to help the model develop contextual understanding of the sequence of table elements.

According to one enhancement of one or more of the above-described computer program products, the computer program product computes for the training, cross-entropy loss for the predictions for the respective masked portions, uses the original portion as a label, and uses a vocabulary set for the transformer architecture machine learning model as a set of possible labels. In this manner, the computer program product uses machine learning loss optimization techniques to help the ML model learn to recognize relevant portions of tabular data to facilitate improved automated search of a data lake.

According to one enhancement of one or more of the above-described computer program products, the computer program products perform masking that includes at least one of whole column name masking and parts-of-table-description masking. In this manner, the computer program product uses existing training data as labels to help a machine learning model receive supervised training to better learn training information and to eventually be able to better perform automated search of a data lake.

According to one enhancement of one or more of the above-described computer program products, the computer system passes the sketches through a linear layer of the transformer architecture machine learning model to produce modified sketches that include same hidden state dimensions as layers of the transformer architecture machine learning model. The modified sketches are used for the combining with the metadata embeddings. In this manner, the computer program product converts sketch information in numerical form into a format that is receivable and useable by a bi-directional encoder text-based transformer machine learning model so that machine learning analysis is performable on the sketch information.

According to one enhancement of one or more of the above-described computer program products, the metadata embeddings include one or more of column name token embeddings, column name token position embeddings, column position embeddings, and column type embeddings. In this manner, the computer program products use specific column metadata to enhance the representation of sketch information that facilitates ease of search for tabular data with numerous rows and columns of data.

According to one enhancement of one or more of the above-described computer program products, the sketches include one or more of numerical sketches, MinHash sketches, and row-based string sketches. In this manner, the computer program products convert specific column data to succinct representations to facilitate ease of search for input samples with respect to large databases which can contain large amount of searchable data in tabular form.

According to one enhancement of one or more of the above-described computer program products, the sketches include numerical sketches that include one or more of number of NaNs, number of unique values, cell width in bytes, percentile sketches, mean value, standard deviation, minimum value, and maximum value. In this manner, the computer program products convert specific column data to succinct numerical representations to facilitate ease of search for input samples with respect to large databases which can contain large amount of searchable data in tabular form.

According to one enhancement of one or more of the above-described computer program products, the sketches include first MinHash sketches for cell values of the columns and also include second MinHash sketches using individual tokens in string columns of the columns. The first MinHash sketches and the second MinHash sketches are concatenated into a single input vector for the string columns. In this manner, the computer program products convert specific column data such as string values to multiple succinct representations to facilitate semantic meaning capture and ease of search for input samples with respect to large databases which can contain large amount of searchable data in tabular form.

According to one enhancement of one or more of the above-described computer program products, the metadata embeddings include column position embeddings ranging from one to a total number of the columns. In this manner, the computer program products use semantics related to positioning of columns within a table to better achieve meaningful search through a data lake.

According to one enhancement of one or more of the above-described computer program products, a respective type of the columns is determined. The metadata embeddings include column type embeddings based on the determining. In this manner, the computer program product identifies data type information in columns in an automated manner to facilitate improved machine learning search through a data lake.

According to one enhancement of one or more of the above-described computer program products, the computer system trains an attention mechanism of the transformer architecture machine learning model to learn N² attention weights between all N tokens for a given table. In this manner, the computer program product implements machine learning techniques to help the ML model recognize most important parts of an input token sequence to facilitate automated search of a data lake.

According to one enhancement of one or more of the above-described computer program products, the objective function includes a table identification task for tables with alternative column ordering. In this manner, the computer program product uses an alternative loss machine learning optimization machine technique to train a machine learning model that can improve dataset discovery over data lakes.

According to one enhancement of one or more of the above-described computer program products, the computer program product performs finetuning of the trained transformer architecture machine learning model for a data discovery task that includes one or more of joinability, unionability, and subset identification. In this manner, the computer program product trains a machine learning model to be more tabular aware is updated to complete a specific desirable task to help with automated search of a data lake.

According to one enhancement of one or more of the above-described computer program product, the computer program product inputs a new dataset in tabular form that includes at least some columns into the trained transformer architecture machine learning model. In response to the inputting, an output from the trained transformed architecture machine learning model is received. In this manner, the computer program product uses a trained machine learning model to help automatically navigate a data lake to find related tables to a tabular input sample.

According to one enhancement of one or more of the above-described computer program products, the output from the trained transformer architecture machine learning model includes one or more of a stored dataset in tabular form that includes at least some columns, a topic to which the new dataset belongs, and a concept to which a particular column of the new dataset belongs. In this manner, the computer program product uses a trained machine learning model to help automatically navigate a data lake to find related tables to a tabular input sample.

According to one enhancement of one or more of the above-described computer program products, the output from the trained transformer architecture machine learning model includes a stored dataset that semantically matches the new dataset. In this manner, the computer program products harnesses machine learning semantic search tools to help automatically navigate a data lake to find related tables to a tabular input sample.

The following described exemplary embodiments provide a computer system, a method, and a computer program product for facilitating search of large repositories of tabular data which includes column-specific organization. Enterprises store critical data in data lakes, which are large repositories of tabular data, for both governance and analytic. The present embodiments facilitate finding relevant tables (e.g., joinable, unionable) within data lakes for reporting, decision-making, statistical analysis, training machine learning models, and more. For instance, unionable table search helps to augment new rows to an existing table and enrich analytics over the existing table. Joinable table search is useful to run analytics that need data in columns from multiple tables, e.g., to identify how many customers in some region purchased a product due to an email campaign. Also, identifying subsets or supersets of a table is helpful when searching for potential copies of personal data to comply with privacy regulations. The present embodiments provide enhanced machine learning model training and usage to achieve these benefits and fulfill these use-cases, focusing on the problem of discovering tables from the data lakes that can be unionable, joinable, and/or subsets of each other.

The present embodiments implement features of machine learning with models that include transformer-based architecture that provide tabular and columnar-specific analysis of tabular-organized data to facilitate data discovery. The present embodiments exploit data sketches of columns of the tabular data and can exploit metadata associated with the tabular data. Instead of linearizing tables as text, the present embodiments create different sketches over the tables. The sketches capture tabular features, which are input into the machine learning models, e.g., into the neural models. The present embodiments improve the technical field of data discovery by pretraining a transformer-based model. In at least some embodiments the transformer implements bi-directional encoder representation. The pretrained model (pretrained with the tabular data and masking) is thereafter finetuned for specific downstream tasks targeting data discovery. The self-attention layers of the transformer architecture help the model achieve superior performance for natural language for combining information across many words in a single sentence to build contextualized embeddings of the column names and sketches. A transformer model is a type of deep learning model that has been applied to a wide range of tasks in machine learning and artificial intelligence including in natural language processing. A key innovation of the transformer model is not having to rely on recurrent neural networks (RNNs) or convolutional neural networks (CNNs). Instead, transformers process input sequences in parallel, making it highly efficient for training and inference. Transformer models need less training time than previous recurrent neural network architectures such as long short-term memory (LSTM).

Instead of computing each component of an input in sequence (e.g. word by word), so that computation can take a long time, the transformer performs positional encoding by assigning a unique number to each word of the input sample. In this way, the transformer gathers information about the position of each token (parts of the input such as words or sub word pieces in NLP) in the sequence, allowing the model to consider the sequence's sequential information. The transformer also implements self-attention features which are a mechanism that calculates weights for every word in a sentence as they relate to every other word in the sentence, so the model can predict words which are likely to be used in sequence. This understanding is learned over time as a model is trained on lots of data. The self-attention mechanism allows each word to attend to every other word in the sequence in parallel, weighing their importance for the current token. In this way, it can be said that machine learning models can “learn” the rules of grammar, based on statistical probabilities of how words are typically used in language.

Transformer models work by processing input data, which can be sequences of tokens or other structured data, through a series of layers that contain self-attention mechanisms and feedforward neural networks. The core idea behind how transformer models work can be broken down into several key steps. The input sentence is first transformed into numerical representations called embeddings. These capture the semantic meaning of the tokens in the input sequence. For sequences of words, these embeddings can be learned during training or obtained from pre-trained word embeddings. Positional encoding is typically introduced as a set of additional values or vectors that are added to the token embeddings before feeding them into the transformer model. These positional encodings have specific patterns that encode the position information. Self-attention operates in multiple “attention heads” to capture different types of relationships between tokens. SoftMax functions, a type of activation function, are used to calculate attention weights in the self-attention mechanism. The model uses layer normalization and residual connections to stabilize and speed up training. The output of the self-attention layer is passed through feedforward layers. These networks apply non-linear transformations to the token representations, allowing the model to capture complex patterns and relationships in the data.

Transformers typically consist of multiple layers stacked on top of each other. Each layer processes the output of the previous layer, gradually refining the representations. Stacking multiple layers enables the model to capture hierarchical and abstract features in the data. In sequence-to-sequence tasks like neural machine translation, a separate decoder module can be added on top of the encoder to generate the output sequence. Some embodiments such as a bi-directional encoder architecture do not use the decoder, however, and instead use task-specific output layers. Transformer models are trained using supervised learning, where they learn to minimize a loss function that quantifies the difference between the model's predictions and the ground truth for the given task. Training typically involves optimization techniques like Adam or stochastic gradient descent (SGD). After training, the model can be used for inference on new data. During inference, the input sequence is passed through the pre-trained model, and the model generates predictions or representations for the given task.

For the transformer embodiment with bi-directional encoder architecture, the transformer is pre-trained on text corpus using techniques of (1) masked language modeling to predict masked words in a text sample and (2) next sentence prediction to predict a sequential order in which multiple sentences would appear in a text corpus.

At least some of the present embodiment start from a basis of the bi-directional encoder architecture and provide further pre-training to the transformer architecture to perform tabular data-related tasks.

The present embodiments also implement aspects of data sketching. Data sketching is a generation of a succinct representation of a set of data. Data sketching is helpful because often the members and size of a total set are too large to allow nimble analysis and processing. For example, a dataset includes eight million members. Analyzing and/or processing the representation of the set of data (as opposed to the entire set itself) is computation resource friendly. Various examples of data sketches are described below for specific embodiments.

At least some of the present embodiments also implement aspects of MinHash sketching. For MinHash sketching, a representation of a dataset is generated and is referred to as a signature. The smallest representation (minimum hash value) is recorded. Multiple hashing techniques are applied and the minimum hash value for each of the separate hashing techniques is recorded. The combination of each of these minimum hash values is the MinHash sketch, i.e., the MinHash signature of the dataset. A signature preserves a permutation of a bit array representation of a set. In the present embodiments, the MinHash sketch takes K independent hash functions and hashes each of the values of a column. The minimum hash value after hashing all values in the column is recorded as the first element of a MinHash signature. Once K MinHashes have been computed, the signature consists of K minimum hash values for the K hash functions. MinHash results can be used for determinations for approximating overlap for two sets without computing pairwise set overlap for each set. MinHash sketches capture a large number of values succinctly, e.g., the values that are located in a column of a table. A data lake may include many millions of tables. To search those, at least some of the present embodiments include building a model that can convert individual column values into embeddings for joinability, unionability etc., so that an efficient approximate nearest neighbors search can be performed to find relevant tables.

The various techniques are implemented via a computer, e.g., via automated action of a training and/or ML usage program 916 when activated, e.g., via a human-computer interaction.

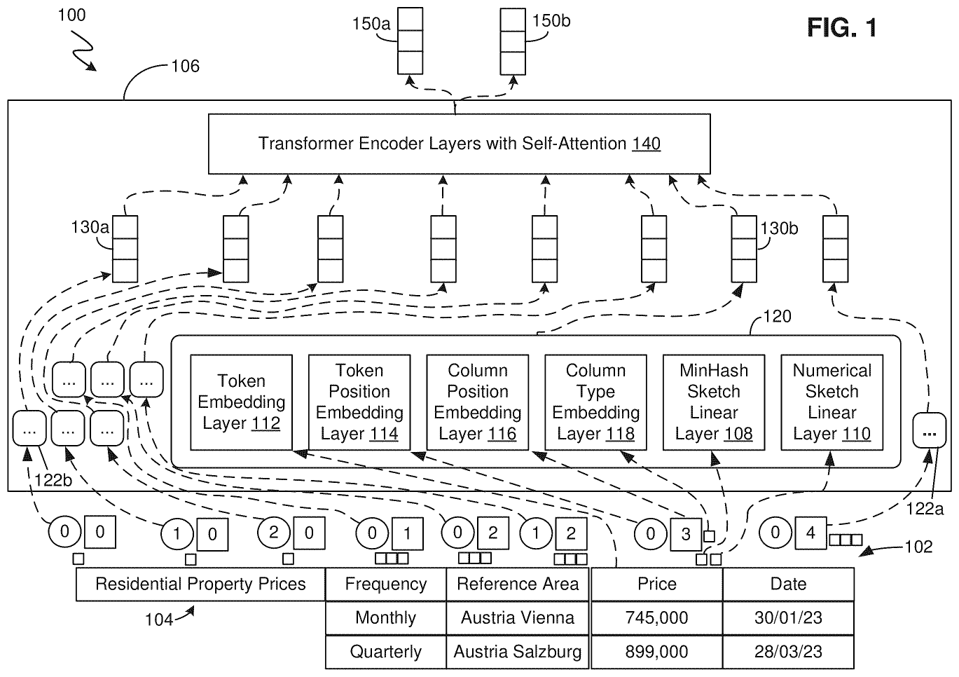

As shown in FIG. 1, training data in tabular form is received. FIG. 1 shows an overview pipeline 100 of how the training data is fed to the self-attention layers of the transformer model. The tabular form includes data organized into rows and columns. A row, e.g., a top row, of the tabular form data includes names of the columns. A first tabular data sample 102 is shown in FIG. 1 with four columns, three rows, and a table title 104 in its own cell of the table 102. The title cell provides a title of the first tabular data sample 102. This tabular data sample 102 is to be input into a transformer architecture based machine learning model 106 to train the model 106 to better understand and analyze tabular data that includes columns. In the present embodiments, the transformer architecture based machine learning model 106 is formed with bi-directional encoder representation. Thus, this model 106 is already pre-trained to better understand words by being trained to perform missing word prediction and next sentence prediction on a large text corpus that is pre-training data.

For the present embodiments, instead of representing the table as input into the model by linearizing the table cell contents and treating them as text, the present embodiments create one or more sketches for each column of the training data sample and feed the sketches as an input to the model 106, i.e., to the transformer architecture. The sketches capture different features of the columns.

In at least some embodiments, as part of initial steps after receiving the data sample in tabular form the program 916 analyzes values of the columns of the data sample to determine a respective type of the columns. The columns include numerical data string-based data, or combinations of those. The numerical data could include dates, integers, or floats. In at least some embodiments, the program 916 analyzes certain values of the columns, e.g., an initial set of the values, e.g., an initial ten values of the columns, to determine if the cell values consistently contain dates, integers, and/or float values. This valuation is for a subset of the cell values in at least some embodiments. The program 916 defaults to a determination that the cell values are for string values if the samples of cell values were not confirmed, e.g., converted, as a specific numerical type. Additional analysis steps of the column values are performed and/or skipped based on this determination of value type. Software commands are used in program 916 to make this determination of data type. As part of the reception of the training data in tabular form, the program 916 receives values of the cells as input and as an initial output indicates a data type held by a respective column. The indication in some embodiments is a combination of multiple data types.

In at least some of the embodiments, the various sketches created from the data sample tables include one or more of: numerical sketches created for the columns of the tables, MinHash sketches created for the columns of the table, and/or row-based content snapshot sketches created for the table.

For the numerical sketches, the sketches include one or more of: the number of not-a-number values (“NaNs”) and the number of unique values (e.g., normalized by the number of rows in the table). NaNs refers to values of a numeric data type which is undefined and/or unrepresentable and that are especially used in floating-point calculations. For example, zero divided by zero represents an NaN value. For string columns, the present embodiments also include for some embodiments a cell width in bytes, because cell width in bytes can be an important determinant in governing if the column is likely to be a join column. For instance, long strings are unlikely to be join candidates. For at least some embodiments, date columns are converted into timestamps and are thereafter treated as numeric columns. For numeric columns, at least some embodiments include the computation of a percentile sketch and one or more of the mean, the standard deviation, and minimum and maximum values. The various features of these possibilities are encoded together as individual elements of a single input vector called the numerical sketch.

For the MinHash sketches, a Min-Hash signature of cell values of a particular column is computed via the program 916. As shown in FIG. 1, the cell value of Austria Vienna is used as a single element in the set passed to the MinHash computation. For string columns, another MinHash signature is also computed for the various tokens within the column. The rationale for this second MinHash is that the tokens can sometimes capture semantics (e.g., if a token street appears in two different columns, they may both be about address, which is useful if one considers a union of two tables that do not necessarily share cell values). As shown in FIG. 1, the cell values of Austria and Salzburg are tokenized and used as two different elements of the set passed to the MinHash computation. In at least some embodiments, both of these first and second Min-Hash sketches are concatenated into a single input vector for string columns. For numerical and date columns, the MinHash for the cell values is included in the input vector.

For the row-based content snapshot sketches, values within each row are concatenated to form a string and a respective MinHash signature is created for each of them. For instance, the last row of the table 102 in FIG. 1 is concatenated into “Quarterly Austria Salzburg 800,000 28/03/23” and is hashed as another MinHash style sketch. This row-based information is helpful in some instances in understanding the table semantics for data discovery.

These sketches are arrays of numbers and an additional modification to these numbers is performed to adapt these sketches to be adaptable to a transformer architecture that implements bi-directional encoder representation. Bi-directional encoder representation transformer models accept sentences or string-values as input instead of sketches. The program 916 passes table-specific scalar inputs as shown in FIG. 1 to the transformer embedding layers. For vector inputs (e.g., numerical sketch, MinHash sketch), additional linear layers for the transformer are added. FIG. 1 shows a MinHash sketch linear layer 108 and a numerical sketch linear layer 110. Via this additional linear layers 108, 110, the sketch information is modified to receive the same hidden state dimensions of the existing transformer layers. These linear layers 108, 110 are part of the transformer-based machine learning model 106. Other embeddings are routed to bypass these linear layers.

FIG. 1 shows the example of the sketches from the “Price” column being input into the linear layers 108, 110 which convert the sketches into the dimensional form accepted by the machine learning model 106. The data from the Price column are input into the embedding section of the transformer-based machine learning model 106 to generate various embeddings which are then combined to form a single embedding that represents the Price column. The date from the Price column are input into the token embedding layer 121, the token position embedding layer 114, the column position embedding layer 116, and the column type embedding layer 118 in addition to the two linear layers 108, 110. All other tokens belonging to the table description and other columns would undergo a similar process to create a single embedding per token and then a combined embedding per column.

For the token embedding layer 112, this layer 112 contains numerical embeddings for each word in its vocabulary based on extensive training with a large corpus, such that, for instance, the embedding of Price might be closely associated with that of House because they co-occur often in text. The token embedding layer 112 of the model 106 is initialized with the weights of the pre-trained model's embedding layer to leverage such information present in natural language, but the weights are allowed to be changed further while pretraining to include co-occurrence information in table-specific corpora. As shown in FIG. 1, the token for “Price” would be mapped from its position in the vocabulary of the model (also pre-populated with the pre-training vocabulary) into its hidden state using weights from this token embedding layer 112.

For the token position embedding layer 114, each column is analogous to a sentence in a paragraph. Hence, this layer generates a positional embedding to reflect a token's position within a column name. For instance, for the “Reference Area” column of the table 102, the “Reference” token receives a position token of “0” while the “Area” token receives a position token of “1” because it is the second token in the cell after “Reference”. Because the other column names include a single token, all of the position tokens for these other column names are “0”. In FIG. 1, these token positions for the various column title tokens are the numbers indicated in the circles located just above the table 102 in FIG. 1.

For the column position embedding layer 116, this embedding is generated via the positions of the columns themselves within the table. This position is encoded with a value which can range from 1 to the total number of columns. For the table 102 shown in FIG. 1, there are five total columns with the table title 104 being considered one of the five total columns. The rationale for including column positions is that they sometimes do have semantics; e.g., a street address next to the city, followed by a zip code. Of course table semantics do not change as a function of column order; nevertheless, this column position token is included in at least some embodiments in case it helps the model 106 understand column semantics, with the assumption that the attentional mechanism would disregard order if necessary.

For the column type embedding layer 118, a column type of the respective column is indicated. Column types of string, date, integer, or float are encoded through another embedding. In order to determine column type, some cell values of the column, e.g., a sub-set of the total cell values, e.g., an initial sub-set of the total cell values, e.g., the initial ten values of the column, are examined to determine their data type. The program 916 parses the cell values as dates, integers, and/or floats. The determination defaults to a determination of “string” values if the values were not convertible to one of the numerical types—dates, integers, and/or floats. Although mixed-type columns hinder clarity of results, at least finding one of the types of a mixed-type column can provide some value. was assigned to these columns. For the various columns shown in the table 102 in FIG. 1, the columns are “string” types except for the Price column which contains “integer” values and the Date column which contains “date” values.

For embodiments with a row-based content snapshot sketch, an additional linear layer similar to the layers 108, 110 is also included to encode this sketch into the same hidden state dimensions of the existing transformer layers in the transformer ML model 106.

FIG. 1 shows an enlargement 120 for the information of the Price column being passed through the embedding layers of the transformer. This enlargement 120 shows the various layers 108, 110, 112, 114, 116, 118 for the information from the Price column. The individual embeddings produced from these six layers for the Price column are combined together for one total embedding from the Price column. The Price total embedding 130b is labeled in FIG. 1.

The same actions occur for the values of the other columns of the Table 102. This includes the Table title 104 being split into three separate tokens—one each for “Residential”, “Property”, and “Price”. The “Reference Area” column is also split into two separate iterations, one each for “Reference” and “Area”. The internal embeddings of these two end up being quite similar with just the 112 and 114 layer embeddings being different. The column position, column type, MinHash sketch embedding, and numerical sketch embedding for the “Reference” and “Area” embedding sets will be the same. Table 102 includes the eight column separations—with four regular columns, the “Reference Area” column split into two, and the Table title 104 split into three portions (3+2+3=8). Thus, the pipeline 100 shows eight separate iterations through the embedding section of the transformer architecture based machine learning model 106. These eight separate iterations include the iteration shown with the enlargement 120 and also the other seven indicators of which second iteration 122a and third iteration 122b are also labeled in FIG. 1.

Each column iteration of a particular table through these embedding layers produces a separate combined embedding (vector representation). Eight combined embeddings are shown in FIG. 1, although two are labeled—a first total embedding 130a and the Price total embedding 130b. The model 106 combines the hidden states of its token embedding, token position embedding, column position embedding, column type embedding, MinHash sketch embedding, and numerical sketch embedding using summation. This summation is similar to the summation of token embeddings and position embeddings in the original BERT model.

Row-based content snapshot signatures (data sketches) are summed with table description tokens because the content snapshot describes the entire table's content. For instance, for the tokens Residential, Property, and Prices from the Table title 104, the row-based content snapshot is passed into the linear layers (e.g., similar to layer 108, 110) to create a hidden state that is combined with the other embeddings for those Table title tokens.

Once each token has been summed with its other sketches, positional and type encoding, the respective total embedding is passed to the rest of the encoder and self-attention layers 140 from the model 106. The attention layers are crucial for contextualizing the embeddings based on what other columns, values, and table descriptions exist in the table.

In at least some embodiments, the model 106 includes an attention mechanism as part of the encoder layers with self-attention 140 which learns N² attention weights between all N tokens for a given table. For the example table 102 shown in FIG. 1, this step will consider “Price” in relation to all other columns as well as to the table descriptions (that were supplemented by the row-based content snapshots). The model 106 includes a twelve-layer bi-directional encoder model with self-attention once the hidden states from the embedding layers and the linear layers are unified. Other embodiments include models with other amounts of the encoder layers, e.g., six layers, twenty-four layers, etc.

The encoder layers 140 produce output vectors 150a, 150b. The number and size of output vectors 150a, 150b are adjustable based on a specific task that is desired to be performed by the model 106. Thus, finetuning is performed to the trained model 106 to adjust the output. The model 106 does not include the decoder layers of a full transformer architecture.

For pretraining the model 106 on tabular data, non-public data, web tables, and/or other enterprise data are used. Unlike enterprise data, web tables often have few rows and columns to ease human consumption and they focus on entities popular on the web (e.g., countries). Their performance may not generalize to enterprise data, where the tables have a large number of rows, the entities are often domain-specific, contain cryptic code words, and have a lot of numerical information. In one embodiment, a de-duplicated pretraining dataset of 197,254 enterprise-like tables (CSV files) are created from CKAN and Socrata that are legally cleared to have the open licenses. Table 1 below shows the average numbers of columns and rows in the tables which are in the order of tens and thousands respectively. This pretraining dataset contains 66% of non-string columns, resembling an enterprise data lake scenario.

TABLE 1

| # | Avg. | Avg. | | | | |
|---|---|---|---|---|---|---|
| Tables | Rows | Cols. | String | Float | Integer | Date |
| 197,254 | 2234.5 | 35.8 | 2,430,684 | 3,768,508 | 630,976 | 231,664 |

For some embodiments data augmentation was performed for the training dataset so that shifting columns in a table does not impact its semantics. This data augmentation is similar to the image processing literature in which different transformations are applied over an original image to generate new image samples for training. This makes the trained model robust on different variants of the same image. The data augmentation for the tabular training data helps make the model robust to the order of columns such that shuffling columns in a table does not impact its semantics. In one data augmentation embodiment, three different versions of the table are created by changing the column order, which in turn, changed the table's content snapshot. This changing increases the total number of pretraining tables to 290,948 and for each of them, data sketch signatures are created as discussed above.

Masking techniques are applied for training the model 106 and for inputting the tabular training data into the model 106. At least some embodiments implement Mask Language Modeling (MLM) as the pretraining objective using the masking principles applied for pretraining in other text-based language models. For the masking, first a few tokens are randomly sampled according to the masked language probability. Then these sampled tokens are substituted with a [MASK] token to create an input sequence. The input sequence is fed to the model, and the model is asked to predict the substituted words. This masking can be viewed as a classification task where the original word is the label and the model's entire vocabulary is the set of possible labels. Cross-entropy loss is computed for each predicted word in the input text that was masked.

$$\frac{- 1}{N} ( {\sum }_{n = 1}^{N} {y}_{i} * log ( {\hat{y}}_{i} ) ) \qquad ( 1 )$$

Equation (1) above defines cross-entropy loss, where yᵢ is the class labels in the ground truth, yᵢ is the predicted class label, and N is the number of training examples in the train set. In other embodiments, other types of loss formulas are able to be implemented.

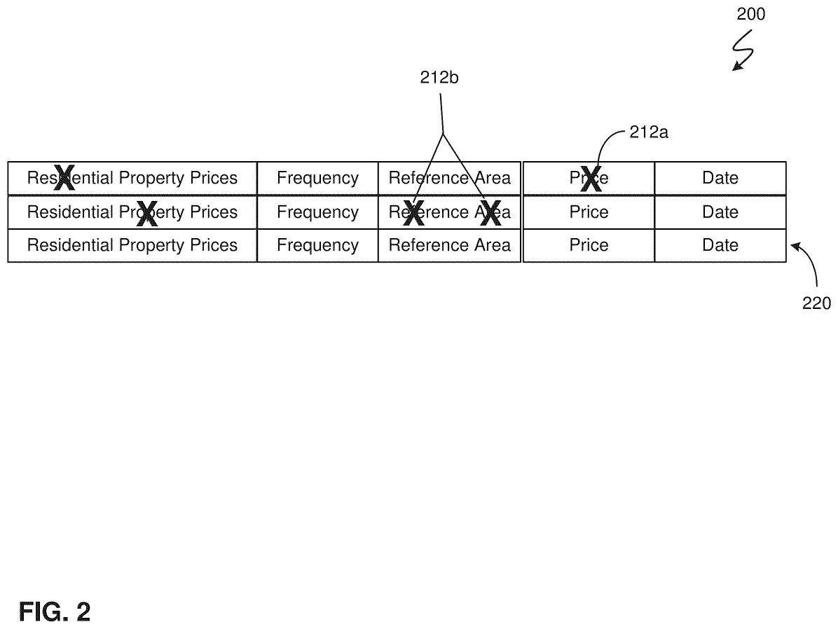

Using the equation (1) for the example table data shown in FIG. 1, for each table, a single column name is masked such that all tokens corresponding to that column are masked. This technique is similar to the natural language literature's whole word masking where all tokens corresponding to a word are masked. In addition, MLM probability is used to mask the tokens in the table description as well. As shown in FIG. 2, several masked samples are generated from a single table. Note that each masking gives an example. For small tables with less than five columns, in some training embodiment each of its columns are masked one after another. However, if a table has a large number of columns, masking each column one after another produces a lot of examples for the same table, over-representing it. So, for large tables with more than five columns, a number of columns, e.g., five columns, are randomly selected and masked. Following this strategy over the augmented pretraining dataset described above, 730,553 examples in training are produced, 54,430 examples in validation, and 58,141 examples in test sets.

FIG. 2 shows masking concepts 200 with various masks over the column names of the sample data. A first mask 212a is labeled over the column name “Price”. Other masks are shown over other portions. Because the column name for the second full column “Reference Area” includes two tokens, both tokens are masked as part of a double mask 212b which illustrates the concept of whole column masking. In FIG. 2, the bottom row is considered labels 220 for the training because this set of complete column name information is used for the loss training when the masking is performed in the other sets. The sketch portions and other column information fed into other layers are not masked.

After pretraining of the model 106, some embodiments include finetuning to adapt the pretrained model to particular data discovery tasks such as unionability, joinability, subset identification, etc. The present embodiments also include the generation of several finetuning datasets for different data discovery tasks using multiple data sources such as open government data from CKAN and Socrata, economic data from the European Central Bank, Spider, and synthesized data from large knowledge graphs such as Wikidata. Crucially, in at least some embodiments, if any table is a part of the pretraining dataset, such table is not additionally used as part of any finetuning dataset. The present embodiments include finetuning datasets to help with identifying unionability, joinability, or subset identification tasks, and a wide range of problem types: binary classification, regression, and multi-label classification. Each benchmark comes with train, test, and validation sets where each example contains a table pair and its label.

For unionability identification tasks, the tabular foundational model deems two tables A and B as “unionable” if a subset of their columns are unionable and deems the as fully unionable if all their columns are unionable. A column c1 from Table A is considered unionable with a column c2 from Table B if they contain values that are drawn from the same domain. While overlap between values in the columns can indicate that they belong to the same domain, columns with few or no overlapping values may also map to the same semantic type or concept. For instance, two columns titled “movie” and “film” might have different movie names in them with no overlap, but they can still be unionable because they map to the same semantic type. Some embodiments perform a union of a new table with an existing table by vertical expansion, (i.e., adding more rows). Some of the present embodiments include generating three datasets for the unionability task: one adapted from existing table search benchmarks, one synthesized from Wikidata, and one from ECB data.

Some unionability training sets were created via (1) finding seed tables selected from unique domains such that they are not unionable with each other and (2) then generating smaller tables from those seed tables by randomly sampling the rows and columns from each seed. The smaller tables generated from the same seed are unionable to each other and the tables from different seeds are not unionable. In some instances, context and the key entity column are preserved during the split. For example, if a seed table contains columns (“person”, “birthplace”, and “birth year”), a first approach might result in a table with (“birthplace” and “birth year”) but without a “person” column, but preserving the key entity column ensures that the “person” column is preserved. These benchmarks were constructed for a search task where the requirement is to retrieve unionable tables from a data lake given a query table. To curate a benchmark for finetuning the pretrained model for the table unionability task, an embodiment includes sampling unionable and non-unionable table pairs and creating a binary classification dataset.

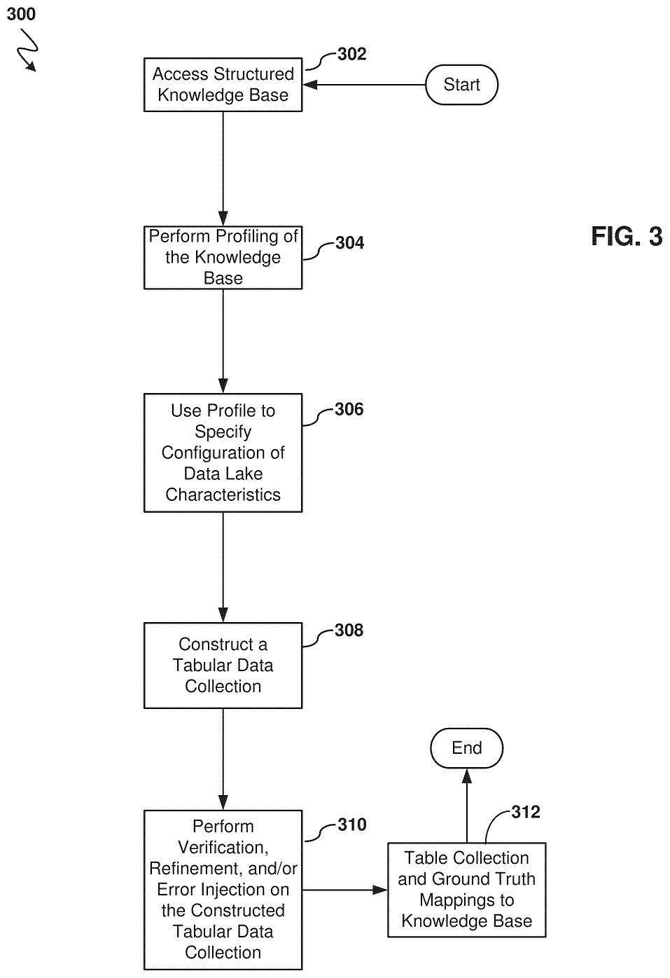

One embodiment for generating unionability finetuning training data includes curating a larger dataset along with ground truth unionability assessment labels. One embodiment includes the table curation process 300 shown in FIG. 3 for generating a unionability or joining finetuning training dataset according to at least one embodiment. In the process 300, a structured knowledge base (KB) is accessed 302 or obtained. The structured knowledge base in some embodiments includes a SPARQL endpoint or other data retrieval framework. The process 300 includes generating a collection of tables describing entities in the input knowledge base. The process starts with creating a “profile” 304 of the ontology of the knowledge base. The profile in at least some embodiments includes of a list of all the classes, the properties of each class, and statistics about the number of instances of each class, the number of values for each property, as well as the data types. Automated modules of the program 916 perform this data profiling. The generated profile is then used to specify 306 a configuration that determines the characteristics of the resulting tabular data lake. The characteristics for some embodiments include: domain (i.e., types of entities), inclusion and prevalence of different data types (e.g., numerical or categorical), the minimum and maximum number of rows and columns in tables, the prevalence of tables that have the same schema, the prevalence of ambiguous entity labels, the amount of noise introduced (if any), the prevalence of tables with null values, and/or the maximum number of tables about the same entity type. The specification is then used to generate 308 a raw collection of tables. Verification, refinement, and/or error injection 310 are performed on the tabular data collection that was generated in step 308. The result 312 can achieve a collection of tables, along with ground truth mappings to the knowledge base. The collection can be exceptionally large in some instances.

In one embodiment, Wikidata is used as the source knowledge base for curating a tabular data collection. The resulting collection consists of large tables with mostly numerical columns, to resemble tabular data found in enterprise data lakes. In some embodiments, a first column in each table contains the labels of entities in the knowledge base. Every other column represents either a relation or a property of the entity. Relation columns contain labels of entities while property columns contain literal values. Some tables may contain null values in some of their rows and one of their columns. The configuration consisted of a subset of Wikidata classes along with only their numerical properties, in addition to a random subset of classes along with all their relations and properties. The configuration specified between two and eight columns, and between twenty and one hundred and twenty rows. Because the classes in Wikidata are quite large and may result in a large number of tables and an unbalanced collection, in one embodiment the number of rows in all the tables for each class were limited to 3,000, the number of tables with the same schema were limited to twenty. The raw collection consists of 46,521 tables, with 3,157,781 mappings of cell values to 1,317,724 unique entities, 72,458 property mappings, and 53,087 column to concept mappings.

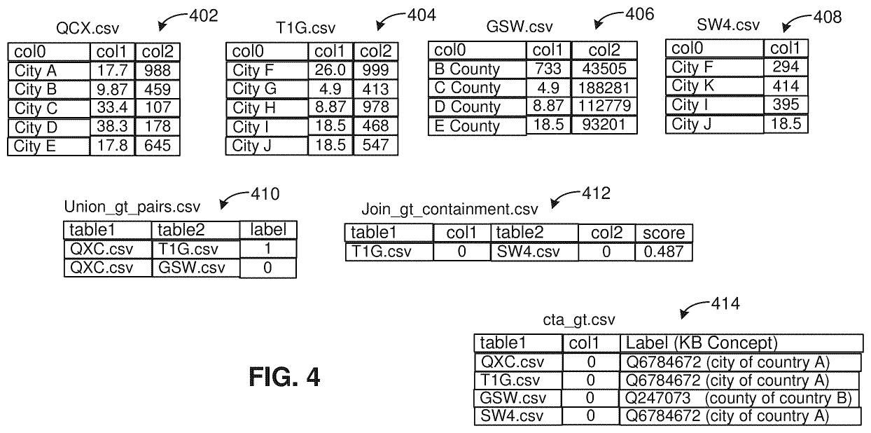

To curate this dataset, two tables are designated as fully unionable if they relate to the same concept and if all their columns map to the same properties in the KB as per the ground truth mappings. The first two tables 402, 404 shown in FIG. 4 are such fully unionable tables. Two kinds of negative labels are created: a) tables in which columns map to the same properties but are about different entities; and b) tables with the same number of columns but not all of their columns map to the same properties. Tables 402 and 406 are a pair of negative examples, with both tables having columns that map to area (col1) and population (col2), but the tables are about different types of entities (counties and cities) and are not unionable. Thus, Table 410 provides a unionability label for some table pairs (1 (positive) label for unionability of tables 402, 404 and 0 (negative) label for table pair 402, 406 not being unionable). The tables 402, 404, 406, and 408 are subsets from the training data. Tables 410, 412, and 414 provide ground truth labels and mapping for the tables 402, 404, 406, 408.

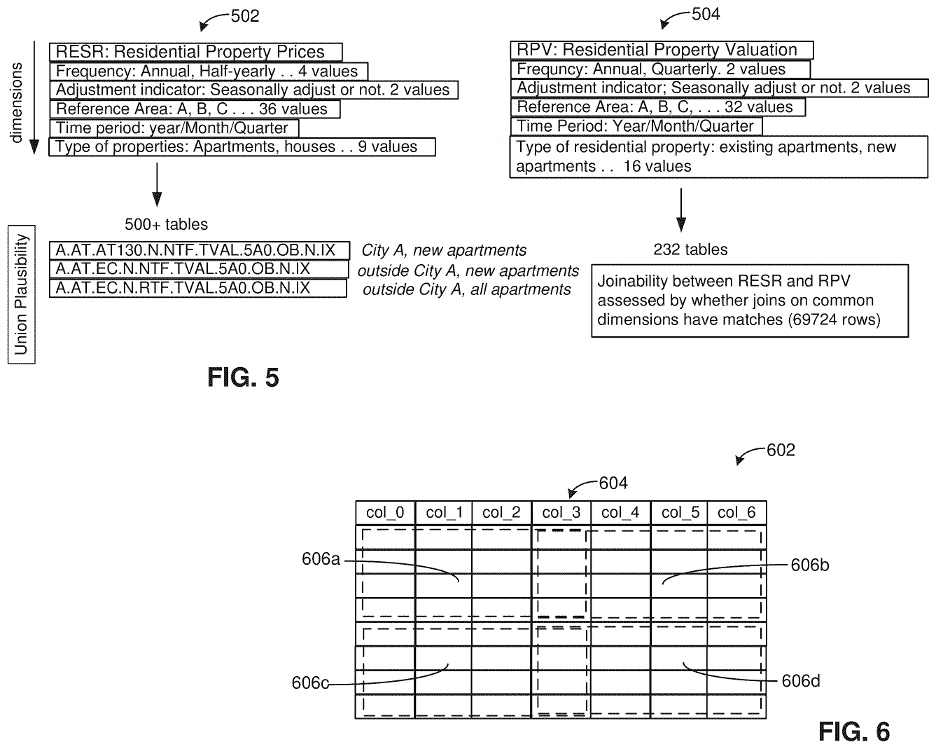

In another embodiment, table data is obtained from bank information about the economy with seventy four datasets each dedicated to a different topic. Each dataset contains a set of time series tables, with varying features from a given dimension. FIG. 5 shows an example from two datasets 502, 504 that are related: residential property prices (RESR) with over 500 tables, and residential property valuation (RPV) with 232 tables. Each table specifies the values for each dimension in the dataset, with different variables representing information about the data of the dataset. A regression task is performed by pairing tables such as the table for City A, new apartments as shown in FIG. 5 with the table for new apartments outside City A, and the table for all apartments outside City A, with the assumption that the plausibility of the union depends on the number of changed values across the dimensions. Therefore, the finetuning training dataset is constructed by ranking each pair by how many dimensions differ, e.g., from one to twelve dimensions in this benchmark dataset. This desired ranking forms a regression task. This regression ranking is performed in an automated manner via the program 916.

Some embodiments include a generation of a finetuning training dataset to finetune the model 106 to perform a joinability determination task. A column c1 from Table A is deemed joinable with a column c2 from Table B if the two columns map to the same semantic type and they have overlapping values. Generally, a new table is joined to an existing table by expanding the existing table horizontally (i.e. to add more features or columns). Various finetuning datasets for joinability output were created from Wikidata, from Spider and CKAN/Socrata, and from and the last reflects existing joins from banking economic data.

For the datasets created from Wikidata, cell entity (CE) mappings are used in the ground truth mappings and joinability scores are assigned to pairs of columns in the collection. Some examples of the joinability score include the Jaccard similarity (size of intersection over the size of the union) across sets of CE mappings, or the minimum containment ratio across the sets of CE mappings which indicates an overlap in the entities in those columns and so a potential for joining. Tables 404 and 408 in FIG. 4 are examples of such tables in the finetuning training dataset benchmark, because they share a number of values in their first column that map to the same knowledge base entity. The tasks for this joinability scoring are modeled as regression tasks.

For a Spider-OpenData finetuning joinability training dataset, two data sources of Spider and CKAN/Socrata open government data were used in one embodiment. Spider is a large-scale human-annotated text-to-SQL dataset annotated by university students. It comes with 10K questions and 200 databases with multiple tables covering 138 different domains. Within each database, joinability is clearly identified via primary/foreign key relationships. Due to the relatively smaller number of tables per database, a small number of join examples were generated from this data. To ensure that enough samples for training and testing various models are obtained, CKAN and Socrata open government data were also used. However, this dataset did not come with manually annotated joins, so the program 916 synthesized joins.

FIG. 6 illustrates this synthesis joining. For every table with at least two columns, 1) a join column was selected at random from the set of columns with mostly unique values that are not floats, 2) the table is sorted based on the join column, and 3) the table is divided around the join column into four quadrants 606a, 606, 606c, 606d shown in FIG. 6. The top two quadrants 606a and 606b as a pair and the bottom two quadrants 606c and 606d as a pair are good candidates for positive joinable tables. Adjacent quadrants share the same cells of the join column 604 (column 3 in this example) and hence are considered a true positive join. To create negative examples, quadrants disposed on the diagonal from each other form two pairs of negative examples (606a and 606d) and (606b and 606c) These negative examples are true negatives and do not share any values of cells in the join column 604.

An example to illustrate FIG. 6 is that one dataset indicates the numbers of rides taken for a bike-sharing program in a city. Supplementing this dataset with weather information could be useful to investigate how the weather effects the number of rides taken, but the weather information is disposed in a different dataset. For the joining of these two sets (bike-shared rides and weather) to add analytical value, the information needs to be for the same dates. If weather information is retrieved for dates on which no bike-share information is available, then the combination provides marginal analytical increase. Compared to the example of FIG. 6, quadrant 606a and 606b could be considered to share the same date information from column 3 by sharing the top four cells of column 3. The lower right weather quadrant 606d includes none of the same dates as the bike sharing quadrant 606a, so combining these two quadrants is of little benefit.

FIG. 5 showed that some of the finetuning datasets have several shared dimensions. FIG. 5 showed the two datasets with a total of 56 dimensions in all, with some tables sharing as many as 18 dimensions. Many of those datasets such as RESR (residential property prices) and RPV (residential property valuations) are related on multiple dimensions. For the join task, all tables within a given dataset are collapsed into a single table to evaluate joins efficiently. Many tables are large; the largest one has over 20 million rows. For each pair of tables, joins were computed on all shared dimensions to see if the result returned any rows. If a row was returned, the dimensions were recorded on which the join was possible to model it as a multi-label classification problem. If the tables shared dimensions but a join resulted in no rows, this was recorded as another label (i.e., no joins are possible). The total dataset had 1780 pairs for training, 222 for valid and 223 for test. This multi-attribute join benchmark is modeled as a multiclass classification task. Although this is a relatively small dataset for finetuning, this dataset is included as it specifies multi-attribute joins on very large, realistic tables, which is difficult to construct synthetically. It is also a measure of how much data is actually needed to finetune a model.

For subset identification tasks for which the model 106 is trained in some embodiments, a Table A is deemed as a subset of Table B if the rows of Table A are contained in B. The subset task is a useful one for governance as it is often useful to trace the provenance of data across tables in a data lake, and to find potential copies of a table (with some modifications). Table subset is defined as a binary classification task. For this finetuning training task, the models were provided with the column names in the table, which meant that positive and negative examples had the exact same schema, but differed in values. A subset benchmark was created using tables from CKAN/Socrata in one embodiment.

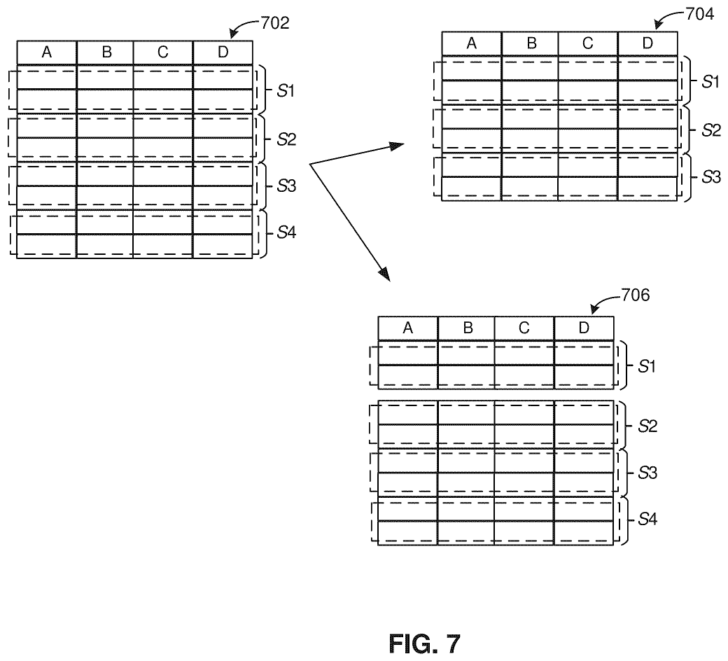

The subset problem becomes challenging when the schemas of the positive and negative examples are exactly the same. But random pairs of tables in the CKAN/Socrata data are most likely to have different schemas. FIG. 7 illustrates a strategy for generating a subset identification task training dataset. Each table greater than 100 rows was partitioned into four equal subsets, S1, S2, S3, and S4 as shown for the ABCD table 702. Each subset Si was paired with a table composed of Si and with two other subsets drawn randomly (e.g., S2, S3 in FIG. 7) for a positive subset example 704, and paired with a table composed of all other subsets (i.e., Sk≠i) for a negative subset example 706. S1 is part of the group S1, S2, S3 so the combination of S1 and S1, S2, S3 (positive subset example 704) is subset affirmative. S1 is not part of the group S2, S3, S4 so the combination of S1 and S2, S3, S4 (negative subset example 706) is subset negative. With this strategy, the number of rows differential for positive and negative pairs could not be used as a signal for whether a pair of tables was a subset or not. Much of the CKAN/Socrata data is de-normalized, so it contains many repeating values in certain columns (e.g., name of a department). These repeating values mean that negative examples often overlap in some of the columns, which makes the subset problem more difficult.

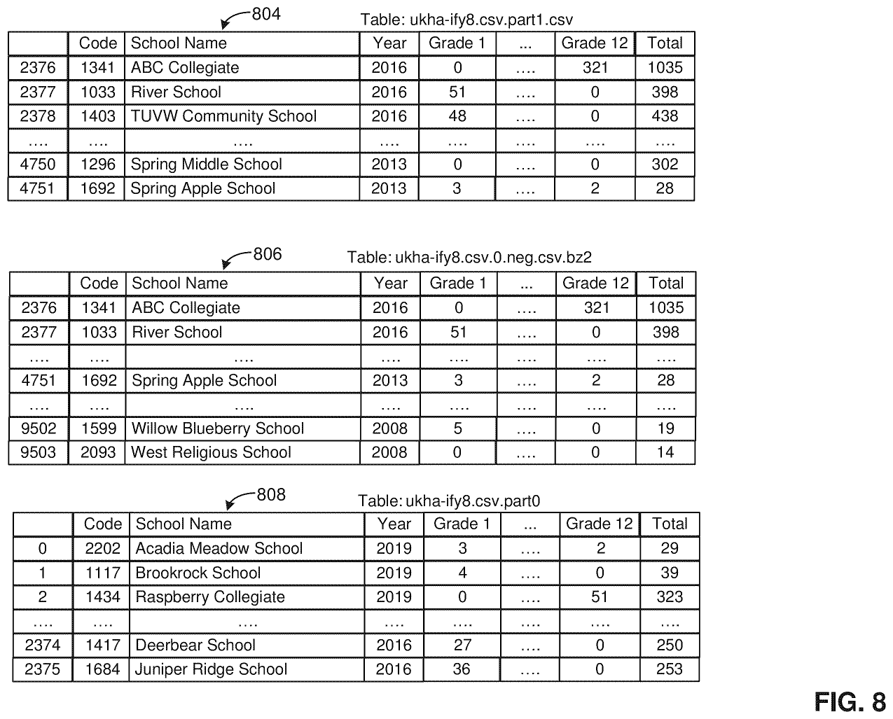

FIG. 8 shows example table subset training data according to one embodiment. FIG. 8 shows that second school table 806 includes a subset of data from first school table 804. However, the third school table 808 does not include any subset of first school table 804 and does not include any subset of second school table 806.

In some embodiments, the transformer based machine learning model 106 is pretrained using four A100 40 GB GPUs for two days, until the model 106 converged. In one embodiment, a patience of five is implemented which means that the model 106 is deemed to have converged if the validation loss does not decrease for more than five epochs. In one embodiment, the pretrained model 106 contains 118 million parameters, similar to other row-based models. For all finetuning tasks, one A100 40 GB GPU was used. Most finetuning tasks converged within six hours using the same five epoch patience as pretraining. Cross-entropy loss for classification tasks, mean squared error for regression tasks, and binary cross-entropy with logit loss for multi-class classification tasks were implemented for some embodiments. For each finetuning task, a cross-encoder was generated and implemented, which evaluates if a pair of tables can be joined, unioned or are subsets of each other. This use of a cross-encoder is considered to be the best way to assess the goodness of a neural model for a specific downstream task.

In performing unionability, joinability, and subset tasks, the sketch and transformer based machine learning model 106 empirically outperformed other foundational models which serialize table as texts. In six of eight tasks, the sketch and transformer based machine learning model 106 outperformed other models. In the other two tasks, the sketch and transformer based machine learning model 106 performed second best of the competing models. These eight tasks included identifying unionability of two different test datasets, identifying joinability of four different test datasets, and identifying subsets with one test dataset. The evaluation metrics included R2 statistics for regression tasks and weighted F1 scores for classification tasks (binary and multiclass). In identifying unionability, in some embodiments the sketch and transformer based machine learning model 106 provides as output one or more unionable table samples from a data lake and/or identifiers of the unionable table samples which can be used to retrieve and display the unionable table samples. In some examples, the output is the unified table samples, namely with the retrieved samples and the input samples combined together. This output is presented, e.g., displayed on a display screen of the computer. In identifying joinability, in some embodiments the sketch and transformer based machine learning model 106 provides as output one or more joinable table samples from a data lake and/or identifiers of the joinable table samples which can be used to retrieve and display the joinable table samples. In some examples, the output is the joined table samples, namely with the retrieved samples and the input samples combined together. This output is presented, e.g., displayed on a display screen of the computer. In identifying subsets, in some embodiments the sketch and transformer based machine learning model 106 provides as output the related-via-subset table samples from a data lake and/or identifiers of the related via subset table samples which can be used to retrieve and display the related-by-subset table samples. The input samples are a subset of the retrieved sample or vice-versa the retrieved sample is a subset of the input sample. The identified related-by-subset samples or an identifier of same is presented, e.g., displayed on a display screen of the computer.

The evaluation tests were further analyzed to determine that the MinHash sketches are crucial for join tasks, that subset selection relies on the overlap of the data distribution, with numerical sketches having a critical effect. Different sketches used play different roles across tasks, and may even interact to effect data discovery performance.

In some embodiments for data lake searching, a two-stage retrieve and re-rank process is implemented with the sketch and transformer-based machine learning model 106. In stage one, the model 106 retrieves candidate matches from the data lake for a given query. In stage two, a cross-encoder that is trained to predict a relevance score for a pair of sequences provides the relevance score and this score is used to re-rank each candidate. For the union search and join search, the model 106 searches for the top-k results (i.e., a set of unionable or joinable tables with the given query table) in the first stage and re-ranks the top-k results using the cross-encoders in the second stage. The original ranking results and the reranked results are compared.

In union search, the task is to find all the tables from a given collection of tables in a data lake that are unionable with the query table. In stage one, we obtain the top-100 results for each query using each method. In stage two, we use our cross-encoder finetuned for the binary classification task using unionability dataset. In at least some embodiments, the predicted scores were used to re-rank the top-k results. In some embodiments, precision and recall metrics were used to evaluate the original and reranked top-k results. For each method, results up to k=60 and k=10 were reported for various benchmarks. The precision for most baselines improves after reranking using the cross-encoder related to the sketch based transformer ML model 106 described herein. The precision improved by over 5% or by over 20% after reranking. Interestingly, sometimes reranking can reduce the performance.

In join search, the task is to find all the tables from the data lake that can be joined on one or more columns with the given query table. For the model 106 described herein, the implemented test is whether it makes sense to join tables. For example, two columns: (i) explaining people's Ages with values such as (50, 24, 66, 78, 92, 95) and (ii) explaining students' marks out of 100 (rounded to integer) with values such as (78, 92, 95, 100, 20) can have overlapping values but it is not sensible to join them because they have different semantics. Because the model 106 described herein is built to generate contextual embeddings of columns that include value overlap, column headings, its context with other columns, and so on, it should be possible to eliminate rid of such useless joins. A search benchmark was constructed by following the cell-entity mapping approach used in the curation of a Wiki Jaccard dataset. Such mappings help to identify if the join is sensible. Precisely, the tables are generated and then a list of all the pairs of joinable columns, i.e., columns with the same entity annotations and overlapping values, is created. The columns having the same entity annotations are deemed to be sensible to join. Each pair is assigned an associated overlap score, which is the Jaccard score of the entity annotation sets. For each column in the list of pairs, a ranked list of joinable columns is created in descending order of their scores.

Similar to union search, the top-100 tables having columns that have the highest approximate Jaccard similarities with the query column were retrieved from datasets. In stage two, the cross-encoder finetuned is used to estimate the Jaccard similarity score for the regression task on the Wiki-Jaccard dataset. Precision and recall metrics were analyzed and reported over original and reranked results. A clear advantage for reranking using the Jaccard scores predicted by the finetuned model 106 was achieved. Thus, the model 106 also helps achieve the advantage of being useable to re-rank search results of a table query.

In some embodiments, the trained model 106 is used for data searching by receiving a new input sample in tabular form and, in response, searching and finding another data sample in tabular form that semantically matches the new input sample. In some embodiments, the semantic matching includes a sematic similarity difference score between various tables falling below a threshold value. In some embodiments, the output from the trained model includes a relationship indicator describing a relationship between the stored dataset and the new dataset. In at least some embodiments, the relationship indicator indicates that the stored dataset and the new dataset contain at least some common information. In at least some embodiments, the output includes the stored dataset and the stored dataset is joinable and/or unionable with the new dataset. In some embodiments, the output is the stored dataset and the input dataset in joined or unioned form.

In some embodiments, the model 106 is trained using an alternative objective function with the combined input vectors (instead of using the masking objective function). In one example of an alternative objective function, multiple pairs of tabular data samples are input to the model 106 and the model 106 has the objective to determine whether the pairs are the same table or not. The test samples are prepared in advance by altering the order of certain columns of the tables. Other pairs of the test samples will use entirely different tables with no common columns (no column common to the pair). The model 106 is trained to learn table understanding by being asked to predict and output whether the input pair is the same table. This particular objective function helps the model learn that tables are invariant to column order. This task is deemed a table identification task for tables with alternative column ordering. The loss function is based on a label of whether the paired input is the same table or is not the same table. In other embodiments, larger groups of tables (more than just two tables) are input for the model to perform the similar task of identifying which tables in the group are the same.

In other embodiments, other objection functions and loss functions are implemented with the combined input vectors (using input elements and data as described herein) to help train the model for improved tabular awareness. In at least some embodiments, labels used for the training are generated automatically by the program 916 for received tabular data samples and no manual (human-performed) labelling of the data samples is necessary to perform the objective loss function for model training.

It may be appreciated that FIGS. 1-8 provide only illustrations of certain embodiments and do not imply any limitations with regard to how different embodiments may be implemented. Many modifications to the depicted embodiment(s), e.g., to particular steps, elements, and/or order of depicted methods or components of a neural network, may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as sketch-based tabular representation learning for dataset discovery over data lakes model training and usage program 916. In addition to sketch-based tabular representation learning for dataset discovery over data lakes model training and usage program 916, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and sketch-based tabular representation learning model training and usage program 916, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

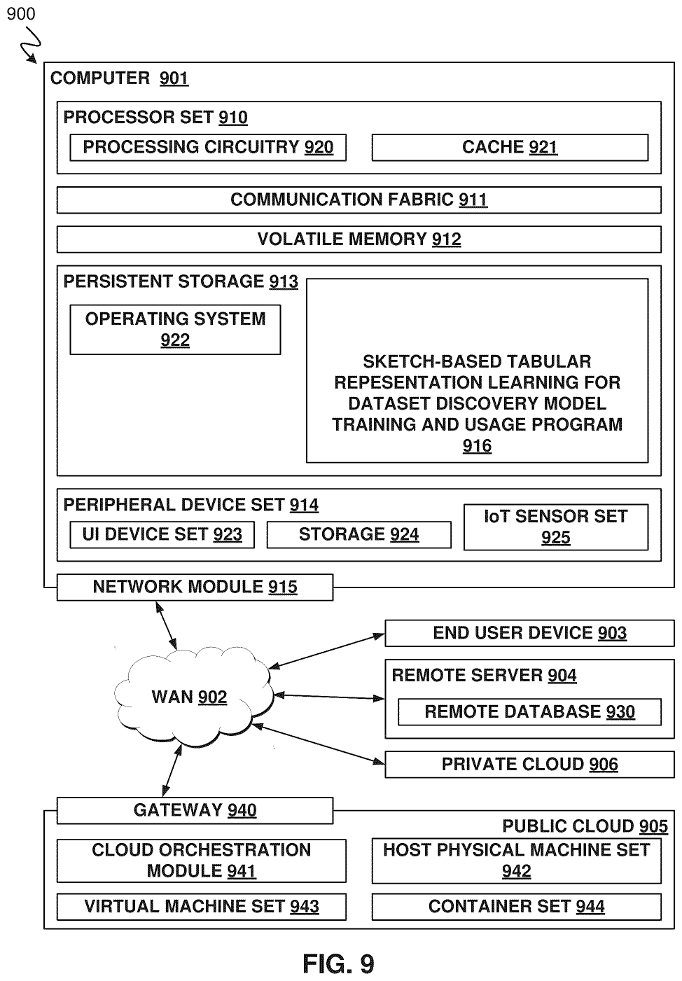

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in sketch-based tabular representation learning for dataset discovery over data lakes model training and usage program 916 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAN¹) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in sketch-based tabular representation learning for dataset discovery over data lakes model training and usage program 916 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing exceptionally large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The computer 901 in some embodiments also hosts one or more machine learning models such as a visual inspection machine learning model. A machine learning model in one embodiment is stored in the persistent storage 913 of the computer 901. A received data sample is input to the machine learning model via an intra-computer transmission within the computer 901, e.g., via the communication fabric 911, to a different memory region hosting the machine learning model.

In some embodiments, one or more machine learning models are stored in computer memory of a computer positioned remotely from the computer 901, e.g., in a remote server 904 or in an end user device 903. In this embodiment, the program 916 works remotely with this machine learning model to train same. Training instructions are sent via a transmission that starts from the computer 901, passes through the WAN 902, and ends at the destination computer that hosts the machine learning model. Thus, in some embodiments the program 916 at the computer 901 or another instance of the software at a central remote server performs routing of training instructions to multiple server/geographical locations in a distributed system.

In such embodiments, a remote machine learning model is configured to send its output back to the computer 901 so that inference and tabular foundation model results from using the trained model to analyze a new tabular sample is provided and presented to a user. The machine learning model receives a copy of the new data sample, performs machine learning analysis on the received sample, and transmits the results, e.g., an output such as a similar dataset, name, column type, etc. back to the computer 901.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
receiving training data in tabular form having at least some columns;
create one or more sketches for contents of the respective columns;
combining the sketches with metadata embeddings of the training data to form respective combined input vectors; and
training a transformer architecture machine learning model by computing loss based on an objective function, inputting the combined input vectors into the transformer architecture machine learning model, and, in response, the transformer architecture machine learning model producing an output.

2. The computer-implemented method of claim 1, wherein the objective function comprises a masking function including masking portions of the combined input vectors so that the transformer architecture machine learning model learns to predict the masked portions.

3. The computer-implemented method of claim 2, wherein the masked portions comprise at least one of column names and table description portions.

4. The computer-implemented method of claim 2, wherein, for the training, cross-entropy loss is computed for the predictions for the respective masked portions, the original portion is a label, and a vocabulary set for the transformer architecture machine learning model is a set of possible labels.

5. The computer-implemented method of claim 2, wherein the masking comprises at least one of whole column name masking and parts-of-table-description masking.

6. The computer-implemented method of claim 1, further comprising passing the sketches through a linear layer of the transformer architecture machine learning model to produce modified sketches comprising same hidden state dimensions as layers of the transformer architecture machine learning model, wherein the modified sketches are used for the combining with the metadata embeddings.

7. The computer-implemented method of claim 1, wherein the metadata embeddings are selected from a group consisting of column name token embeddings, column name token position embeddings, column position embeddings, and column type embeddings.

8. The computer-implemented method of claim 1, wherein the sketches are selected from a group consisting of numerical sketches, MinHash sketches, and row-based string sketches.

9. The computer-implemented method of claim 1, wherein the sketches comprise numerical sketches selected from a group consisting of number of NaNs, number of unique values, cell width in bytes, percentile sketches, mean value, standard deviation, minimum value, and maximum value.

10. The computer-implemented method of claim 1, wherein the sketches comprise:
first MinHash sketches for cell values of the columns, and
second MinHash sketches using individual tokens in string columns of the columns; and
wherein the first MinHash sketches and the second MinHash sketches are concatenated into a single input vector for the string columns.

11. The computer-implemented method of claim 1, wherein the metadata embeddings comprise column position embeddings ranging from one to a total number of the columns.

12. The computer-implemented method of claim 1, further comprising determining a respective type of the columns, wherein the metadata embeddings comprise column type embeddings based on the determining.

13. The computer-implemented method of claim 1, wherein for the training an attention mechanism of the transformer architecture machine learning model further learns N² attention weights between all N tokens for a given table.

14. The computer-implemented method of claim 1, wherein the objective function comprises a table identification task for tables with alternative column ordering.

15. The computer-implemented method of claim 1, further comprising finetuning the trained transformer architecture machine learning model for a data discovery task selected from a group consisting of joinability, unionability, and subset identification.

16. The computer-implemented method of claim 1, further comprising:
inputting a new dataset in tabular form comprising at least some columns into the trained transformer architecture machine learning model; and
in response to the inputting, receiving a trained model output from the trained transformed architecture machine learning model.

17. The computer-implemented method of claim 16, wherein the trained model output is selected from a group consisting of a stored dataset in tabular form comprising at least some columns, a topic to which the new dataset belongs, and a concept to which a particular column of the new dataset belongs.

18. The computer-implemented method of claim 16, wherein the trained model output comprises a stored dataset and the stored dataset semantically matches the new dataset.

19. A computer system comprising:
one or more processors, one or more computer-readable memories, and program instructions stored on at least one of the one or more computer-readable memories for execution by at least one of the one or more processors to cause the computer system to:
receive training data in tabular form having at least some columns;
create one or more sketches for contents of the respective columns;
combine the sketches with metadata embeddings of the training data to form respective combined input vectors; and
train a transformer architecture machine learning model by computing loss based on an objective function, by inputting the combined input vectors into the transformer architecture machine learning model, and, in response, the transformer architecture machine learning model producing an output.

20. A computer program product comprising a computer-readable storage medium having program instructions embodied therewith, the program instructions executable by a computer to cause the computer to:
receive training data in tabular form having at least some columns;
create one or more sketches for contents of the respective columns;
combine the sketches with metadata embeddings of the training data to form respective combined input vectors; and
train a transformer architecture machine learning model by computing loss based on an objective function, by inputting the combined input vectors into the transformer architecture machine learning model, and, in response, the transformer architecture machine learning model producing an output.
